(19) United States
(12) Patent Application Publication
(10) Pub. No.: US 2014/0133190 A1
(43) Pub. Date: May 15, 2014

(54) ISOLATED SWITCH-MODE DC/DC CONVERTER WITH SINE WAVE TRANSFORMER VOLTAGES

(71) Applicant: Murata Manufacturing Co., Ltd., Nagaokakyo-shi (JP)

(72) Inventor: Alexander ASINOVSKI, Stoughton, MA (US)

(73) Assignee: MURATA MANUFACTURING CO., LTD., Nagaokakyo-shi (JP)

(21) Appl. No.: 14/159,544

(22) Filed: Jan. 21, 2014

Related U.S. Application Data
(63) Continuation of application No. PCT/US2012/054109, filed on Sep. 7, 2012.
(60) Provisional application No. 61/532,663, filed on Sep. 9, 2011.

(51) Int. Cl. H02M 3/335

(52) U.S. Cl. CPC H02M 3/33592
USPC 363/21.03

(57) ABSTRACT

A converter includes a transformer including a primary winding and a secondary winding, a primary-side circuit connected to first and second input terminals and to the primary winding and including a switching circuit connected to the primary winding and a parallel resonant tank circuit including the primary winding and a resonant capacitor connected in parallel with the primary winding, a secondary-side circuit connected to the secondary winding and to first and second output terminals and including a rectifier circuit connected to the secondary winding, and an inductor including a primary inductor winding connected to the first input terminal and the primary winding and a secondary inductor winding connected to the secondary winding and the first output terminal.

### BACKGROUND OF THE INVENTION

1. Field of the Invention

The present invention relates to power conversion. More specifically, the present invention relates to isolated DC/DC converters.

2. Description of the Related Art

Known techniques for power conversion include a zero voltage switching (ZVS) technique and/or a resonant conversion technique. One conventional topology uses a ZVS bridge that requires an additional resonant inductor. Another known technique uses an LLC resonant converter that requires a relatively low magnetizing inductance for ZVS, resulting in excessive losses at light- and no-load conditions. The drawbacks of conventional approaches are added complexity and/or light load efficiency reduction.

### SUMMARY OF THE INVENTION

To overcome the problems described above, preferred embodiments of the present invention provide a converter that solves the switching loss problem, allowing for a higher frequency operation and for a greater power density.

According to preferred embodiments of the present invention, a converter includes a transformer including a primary winding and a secondary winding, a primary-side circuit connected to first and second input terminals and to the primary winding and including a switching circuit connected to the primary winding and a parallel resonant tank circuit including the primary winding and a resonant capacitor connected in parallel with the primary winding, a secondary-side circuit connected to the secondary winding and to first and second output terminals and including a rectifier circuit connected to the secondary winding, and an inductor including a primary inductor winding connected to the first input terminal and the primary winding and a secondary inductor winding connected to the secondary winding and the first output terminal.

The primary-side circuit further preferably includes a clamp circuit connected to the first input terminal. The clamp circuit is also preferably connected to either the switching circuit or the primary winding.

The primary inductor winding is preferably connected to the primary winding through the switching circuit. The secondary inductor winding is preferably connected to the secondary winding through the rectifier circuit. The inductor further preferably includes an auxiliary inductor winding connected between the second input terminal and the clamp circuit.

The following ratio is preferably satisfied: N_{pT}/N_{sT}=N_{pI}/N_{sI}, where N_{pT} is a number of turns in the primary winding, N_{sT} is a number of turns in the secondary winding, N_{pI} is a number of turns in the primary inductor winding, and N_{sI} is a number of turns in the secondary inductor winding.

The primary inductor winding and the secondary inductor winding are preferably coupled together by a magnetic core. The primary inductor winding, the secondary inductor winding, and the primary auxiliary inductor winding are preferably coupled together by a magnetic core.

The switches of the switching circuit are preferably switched at a frequency equal to a resonant frequency of the parallel resonant tank.

The primary-side circuit further preferably includes additional resonant capacitors connected across corresponding switches of the switching circuit. The primary-side circuit further preferably includes a capacitor connected across the first and second input terminals. The secondary-side circuit further preferably includes an additional resonant capacitor connected across the secondary winding.

The secondary-side circuit further preferably includes an output capacitor connected in parallel across the first and second output terminals. The output capacitor and the secondary inductor winding are preferably connected together to define an output filter.

The switching circuit preferably includes at least two MOSFETs. The rectifier circuit preferably includes at least two rectifiers. The at least two rectifiers are preferably MOSFETs. The at least two rectifiers are preferably diodes. The switching circuit preferably has either a full-bridge or a push-pull topology. The rectifier circuit preferably has either a full bridge or a center-tap scheme.

The above and other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a converter according to a first preferred embodiment of the present invention.

FIG. 2 is a circuit diagram of a converter according to a second preferred embodiment of the present invention.

### DETAILED DESCRIPTION OF PREFERRED EMBODIMENTS

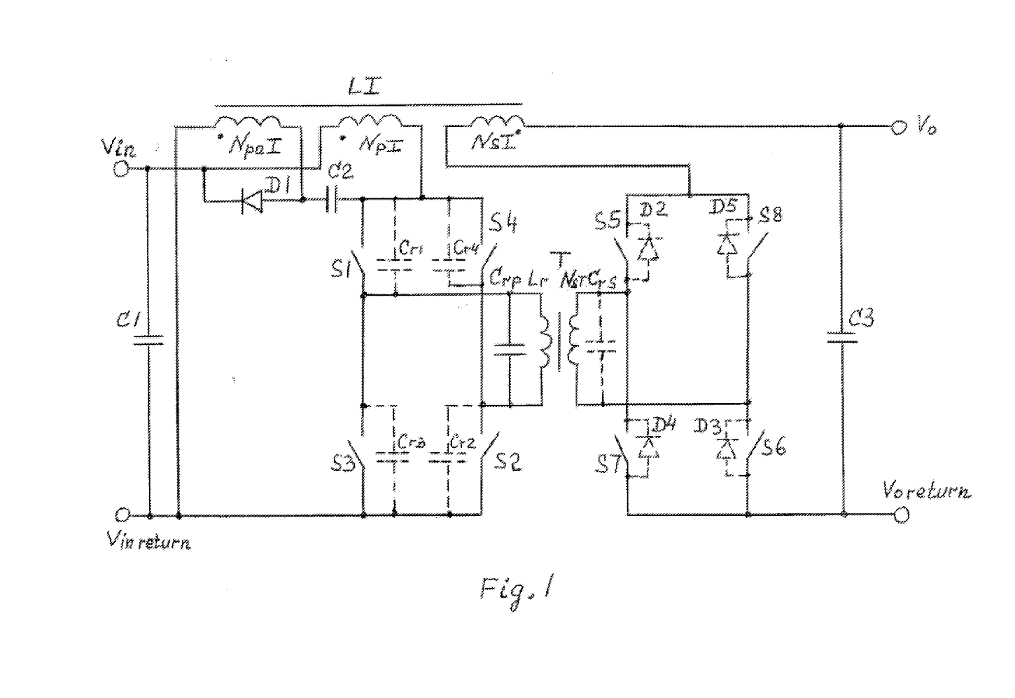

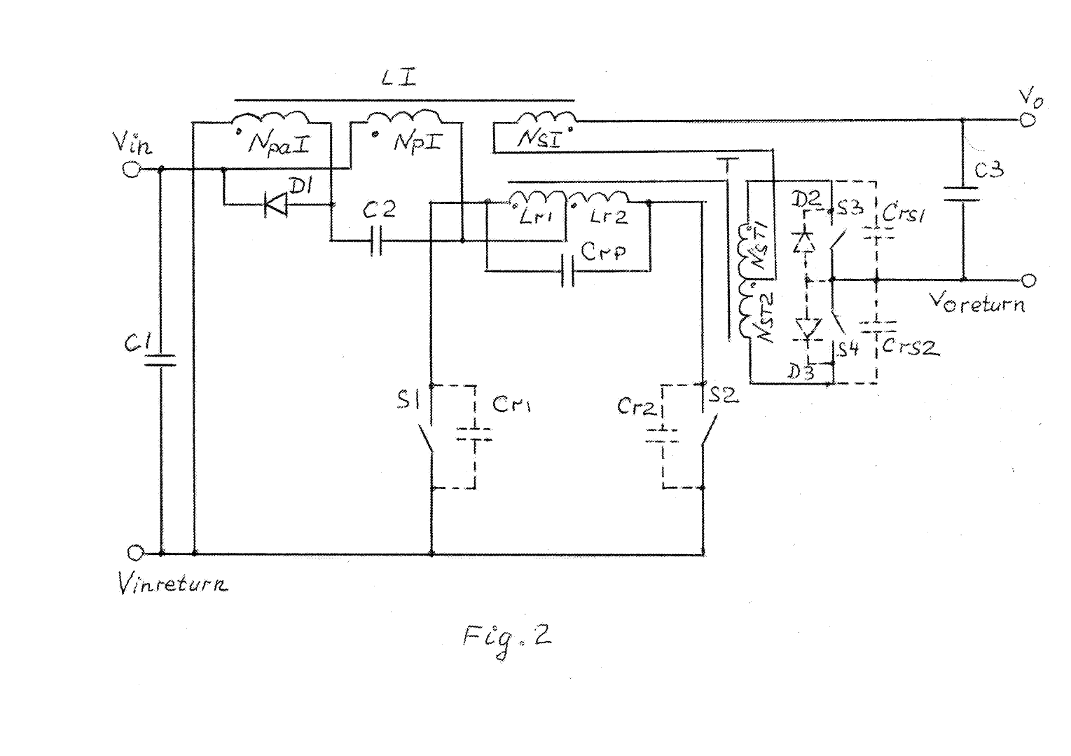

Preferred embodiments of the present invention are shown in FIGS. 1 and 2 and allow a ZVS mode of operation in a wide load range, including from no load to full load. As long as the switching frequency of the primary switches is equal to the resonant tank frequency, a ZVS mode of operation is maintained under all operational conditions, including from no load to full load. Because of the sine-wave transformer and the half-sine-wave power-switch voltages and because of the virtual elimination of switching losses and capacitive losses in the power switches, a higher frequency is achieved and consequently power density is improved.

The preferred embodiments of the present invention preferably use full-bridge (FB) and push-pull (PP) converter topologies with FB and center-tap (CT) output rectifier schemes. FB and PP converter topologies are current-fed double-ended topologies. It is also possible to use current-fed single-ended topologies that include a parallel resonant tank.

The converter according the first preferred embodiment of the present invention is shown in FIG. 1. The converter shown in FIG. 1 preferably includes four primary switches S₁, S₂, S₃, and S₄ arranged as a primary full-bridge circuit; a high-frequency parallel resonant tank that includes resonant capacitor Cᵣₚ and resonant inductor Lᵣ that is the primary winding of the high-frequency transformer T; an inductor LI that includes primary power winding N_{pI}, secondary power winding N_{sI}, and auxiliary primary winding N_{paI}; a clamp circuit that includes capacitor C2 and diode D1 connected to the primary power winding N_{pI}; a secondary winding N_{ST} of the transformer T connected to the secondary rectifiers S₅, S₆, S₇, and S₈ that are arranged as a secondary full-bridge circuit that is connected to the secondary power winding N_{sI} of the inductor LI; a capacitor C1 connected across input terminals Vᵢₙ and V_{in return}; and a capacitor C3 connected across output terminals Vₒ and V_{o return}. The auxiliary primary winding N_{paI} does not carry input power current proportional to the output current, while the primary power winding N_{pI} does carry input power current proportional to the output current. Additionally, the resonant capacitors Cᵣ₁, Cᵣ₂, Cᵣ₃, and Cᵣ₄ can be optionally connected across corresponding ones of the primary switches S₁, S₂, S₃, and S₄, and resonant capacitor Cᵣₛ can be optionally connected across the secondary winding N_{sT} of the transformer T.

The principle of operation of the converter shown in FIG. 1 is as follows. The primary switches S₁, S₂, S₃, and S₄ are controlled by applying rectangular voltages at the operating frequency F_{sw} and with a duty cycle slightly greater than 50%. The control circuit that controls the primary switches S₁, S₂, S₃, and S₄is not shown in FIG. 1. The primary switches S₁ and S₂ are ON during the first half of switching period (T_{sw}=1/F_{sw} plus a small overlapping time δT_{sw}), and the primary switches S₃ and S₄ are ON during the overlap time δT_{sw} and the second half of switching period. That is, all four primary switches S₁, S₂, S₃, and S₄ conduct during the overlap time δT_{sw}. The four primary switches S₁, S₂, S₃, and S₄ conduct during the overlap time δT_{sw} so that the inductor current is uninterrupted. If a dead time is used instead of the overlap time δT_{sw}, the energy stored in the inductor LI would be released during the dead time in the form of very high and dangerous voltage spikes.

In one mode of operation, the switching frequency F_{sw} is equal to the resonant frequency of the parallel resonant tank, i.e., F_{sw}=1/(2π*√(Lᵣ*Cᵣ), where Cᵣ is the capacitance of the equivalent resonant capacitor defined by Cᵣₚ and the optional capacitors Cᵣ₁, Cᵣ₂, Cᵣ₃, Cᵣ₄, and Cᵣₛ and where Lᵣ is the inductance of the resonant inductor Lᵣ. As long as the switching frequency of the primary switches S₁, S₂, S₃, and S₄is set to the resonant tank frequency, a ZVS mode of operation is maintained under all operational conditions, including from no load to full load. Inductance L of the primary power winding N_{pI} of inductor LI is selected to be large enough so that the input current does not change significantly during the switching period T_{sw} and so that the parallel resonant tank is driven by square wave current pulses of fixed magnitude defined by the load current. The quality factor of the parallel resonant tank is selected to be large enough so that the voltages across the resonant inductor Lᵣ, which is the primary winding of the transformer T, across the diagonal of the primary full-bridge circuit, and across the secondary winding N_{sT} of the transformer T are of the sinusoidal type and so that the corresponding voltages across the primary switches S₁, S₂, S₃, and S₄ and the secondary rectifiers S₅, S₆, S₇, and S₈ are of the half-sine-wave type. Because the average voltage across the primary full-bridge circuit is equal to the input voltage Vᵢₙ, the sine wave magnitude V_{bm} across the transformer primary and across each of the primary switches S₁, S₂, S₃, and S₄ is equal to:

V_{bm}=Vᵢₙ*π/2. (1)

The secondary transformer voltage and the voltages across each of the secondary rectifiers S₅, S₆, S₇, and S₈ is defined by the input voltage Vᵢₙ and by the transformer turns ratio N_{pT}/N_{sT}. The magnitude of the secondary transformer voltage is (Vᵢₙ*π/2)/(N_{pT}/N_{sT}). An output filter circuit is provided by the secondary power winding N_{sI} and the output capacitor C3. This output filter circuit averages the voltage rectified by the secondary full-bridge circuit so that the output voltage Vₒ is essentially of a DC type:

Vₒ=(Vᵢₙ*π/2)/(N_{pT}/N_{sT})*(2/π)=Vᵢₙ*N_{sT}/N_{pT}. (2)

According to equation (2), the output voltage Vₒ is directly proportional to the input voltage Vᵢₙ with a slope factor defined by the transformer turns ratio N_{sT}/N_{pT}. The dotted ends of the primary power winding N_{pI} and the secondary power winding N_{sI} are connected to the input terminal Vᵢₙ and the output terminal Vₒ, respectively; the non-dotted ends of the primary power winding N_{pI} and the secondary power winding N_{sI} are connected to the top terminals of the primary full-bridge circuit and the secondary full-bridge circuit, respectively. The inductor's LI turns ratio is set to be equal to the transformer turns ratio: N_{pI}/N_{sI}=N_{pT}/N_{sT}-ᵣ. This ensures that the secondary voltages created by the transformer T and inductor LI are matched.

The DC current in the primary power winding N_{pI} is flying from the input terminal V_{in return} to the dotted end of the primary power winding N_{pI}, and the DC current in the secondary power winding N_{sI} is flying from the top terminal of the secondary full-bridge circuit to the non-dotted end of the secondary power winding N_{sI}, resulting in the DC flux cancellation in the magnetic core of the inductor LI. In turn, this DC flux cancellation results in a relatively small inductor size for the inductor LI. If the primary power winding N_{pI} and the secondary power winding N_{sI} are not coupled, the converter can operate in the same way, but the inductors corresponding to the primary power winding N_{pI} and the secondary power winding N_{sI} are subjected to input and output DC bias currents, respectively, resulting in the need for inductors with larger magnetic core sizes.

The clamp circuit including capacitor C2 and diode D1 connected to the auxiliary primary winding N_{paI} works in the following manner. The capacitor C2 is selected to be large enough to ensure that the DC voltage \Opplied across the capacitor C2 has small ripples. That DC voltage V_{c} is equal to the input voltage Vᵢₙ because the capacitor C2 is connected to the input terminal Vᵢₙ through the primary power winding N_{pI} and to the input terminal V_{in return} through the auxiliary primary winding N_{paI}. The forward voltage VF applied to diode D1 is equal to V_{b}−V_{c}−Vᵢₙ, where V_{b} is the voltage across the primary full-bridge circuit at the non-dotted end of the primary power winding N_{pI} with respect to V_{in return} and V_{c} is the voltage across the capacitor C2. Because V_{c}=Vᵢₙ,

VF=V_{b}−2*Vᵢₙ. (3)

Under steady state conditions, V_{b}≦Vᵢₙ*π/2<2*Vᵢₙ according to equation (1), the forward voltage VF is negative according to equation (3), the diode D1 is reverse biased, and the clamp circuit is not activated. Under transient conditions, for example, when the load current goes to zero with a high slew rate, the input inductor energy is released, resulting in a voltage spike across the primary full-bridge circuit. At the instant that voltage V_{b} exceeds twice the voltage level of the input terminal Vᵢₙ, the diode D1 is forward biased (see equation (3)), and the inductor energy is recovered to the input capacitor C1 and to the input source connected to the input terminals Vᵢₙ and V_{in return}. As a result, the voltage V_{b} and the corresponding voltages across the primary switches S₁, S₂, S₃, and S₄ are clamped at twice the voltage level of the input terminal Vᵢₙ plus the voltage drop across the diode D1. The capacitors C1 and C2 connect the dotted and non-dotted terminals of the coupled primary power winding N_{pI} and the auxiliary primary winding N_{paI}, respectively. Because the inductances of the primary power winding N_{pI} and the auxiliary primary winding N_{paI} are connected in parallel at AC voltages, the numbers of turns of the primary power winding N_{pI} and the auxiliary primary winding N_{paI} are selected to be equal. If the primary power winding N_{pI} connected to the clamp circuit is not coupled to the auxiliary power winding N_{paI}, the clamp circuit works the same way at the expense of an additional magnetic component, an auxiliary inductor equivalent to N_{paI}.

The secondary rectifiers S₅, S₆, S₇, and S₈ can be uncontrolled diodes D2, D3, D4 and D5 as shown with dashed lines in FIG. 1 or can be controlled switches or transistors, preferably MOSFETs, which would be used with a corresponding synchronous rectification control scheme. The synchronous rectification control scheme is not shown in FIG. 1. The secondary rectifier scheme can be a center-tap type scheme instead of the full-bridge type scheme shown in FIG. 1. The primary switches S₁, S₂, S₃, and S₄ are preferably MOSFETs.

The converter of the second preferred embodiment of the present invention is shown in FIG. 2. The primary side of the converter shown in FIG. 2 is configured as a current-fed push-pull topology. The secondary rectifiers S₃ and S₄ are configured according to a center-tap scheme. The converter shown in FIG. 2 operates in a similar manner as the converter shown in FIG. 1. The secondary rectifiers S₃ and S₄ are configured in a center-tap type scheme; the secondary rectifiers S₃ and S₄ can also be configured in a full-bridge type scheme as shown in FIG. 1. The push-pull converter shown in FIG. 2 preferably includes half as many switches as the full-bridge converter shown in FIG. 1, and the push-pull converter shown in FIG. 2 is suitable for applications requiring a smaller power level. Because each of the primary switches S₁ and S₂ has one terminal connected to the terminal V_{in return} and each of the secondary rectifiers S₃ and S₄ has one terminal connected to the output terminal V_{o return}, the primary-side and secondary-side switch control circuits (not shown in FIG. 2) are simplified.

The capacitor C2 is selected to be large enough to ensure that the DC voltage V_{c} applied across the capacitor C2 has small ripples. Accordingly, the DC voltage V_{c} is equal to the input voltage Vᵢₙ because the capacitor C2 is connected to the input terminal Vᵢₙ through the primary power winding N_{pI} and to the input terminal V_{in return} through the auxiliary primary winding N_{paI}. The forward voltage VF applied to diode D1 is equal to V_{ct}−V_{c}−Vᵢₙ, where V_{ct} is the voltage at the center tap of the primary winding of the power transformer T with respect to V_{in return} and V_{c} is the voltage across the capacitor C2. Because V_{c}=Vᵢₙ,

VF=V_{ct}−2*Vᵢₙ. (4)

Under steady state conditions, the peak voltage V_{ctm} at the center tap of the primary winding of the power transformer T with respect to V_{in return}, similar to equation (1), is V_{ctm}=Vᵢₙ*π/2, V_{ct}≦Vᵢₙ*π/2<2*Vᵢₙ, and according to equation (4) the forward voltage VF is negative, the diode D1 is reverse biased, and the clamp circuit is not activated. Under transient conditions, for example, when the load current goes to zero with a high slew rate, the input inductor energy is released, resulting in a voltage spike at the center tap of the primary winding of the power transformer T. At the instant that voltage V_{ct} exceeds twice the voltage level of the input terminal Vᵢₙ, the diode D1 is forward biased (see equation (4)), and the inductor energy is recovered to the input capacitor C1 and to the input source connected to the input terminals Vᵢₙ and V_{in return}. As a result, the voltage V_{ct} is clamped at twice the voltage level of the input terminal Vᵢₙ plus the voltage drop across the diode D1 and the corresponding voltages across the primary switches S_{1 and} S₂ are clamped at twice the center tap voltage level. The capacitors C1 and C2 connect the dotted and non-dotted terminals of the coupled primary power winding N_{pI} and the auxiliary primary winding N_{paI}, respectively. Because the inductances of the primary power winding N_{pI} and the auxiliary primary winding N_{paI} are connected in parallel at AC voltages, the numbers of turns of the primary power winding N_{pI} and the auxiliary primary winding N_{paI} are selected to be equal. If the primary power winding N_{pI} connected to the clamp circuit is not coupled to the auxiliary power winding N_{paI}, the clamp circuit works the same way at the expense of an additional magnetic component, such as an auxiliary inductor equivalent to N_{paI}.

The converters shown in FIGS. 1 and 2, operating as described above, produce non-regulated output voltage directly proportional to the input voltage. Output voltage regulation can be achieved by conventional techniques, for example, by switching frequency modulation.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A converter comprising:
a transformer including a primary winding and a secondary winding;
a primary-side circuit connected to first and second input terminals and to the primary winding and including:
a switching circuit connected to the primary winding; and
a parallel resonant tank circuit including the primary winding and a resonant capacitor connected in parallel with the primary winding;
a secondary-side circuit connected to the secondary winding and to first and second output terminals and including a rectifier circuit connected to the secondary winding; and
an inductor including:
a primary inductor winding connected to the first input terminal and the primary winding; and
a secondary inductor winding connected to the secondary winding and the first output terminal.

2. A converter according to claim 1, wherein the primary-side circuit further includes a clamp circuit connected to the first input terminal.

3. A converter according to claim 2, wherein the clamp circuit is also connected to either the switching circuit or the primary winding.

4. A converter according to claim 1, wherein the primary inductor winding is connected to the primary winding through the switching circuit.

5. A converter according to claim 1, wherein the secondary inductor winding is connected to the secondary winding through the rectifier circuit.

6. A converter according to claim 2, wherein the inductor further includes an auxiliary inductor winding connected between the second input terminal and the clamp circuit.

7. A converter according to claim 1, wherein:
N_{pT}/N_{sT}=N_{pI}/N_{sI}
where N_{pT} is a number of turns in the primary winding, N_{sT} is a number of turns in the secondary winding, N_{pI} is a number of turns in the primary inductor winding, and N_{sI} is a number of turns in the secondary inductor winding.

8. A converter according to claim 1, wherein the primary inductor winding and the secondary inductor winding are coupled together by a magnetic core.

9. A converter according to claim 1, wherein switches of the switching circuit are switched at a frequency equal to a resonant frequency of the parallel resonant tank.

10. A converter according to claim 1, wherein the primary-side circuit further includes additional resonant capacitors connected across corresponding switches of the switching circuit.

11. A converter according to claim 1, wherein the primary-side circuit further includes a capacitor connected across the first and second input terminals.

12. A converter according to claim 1, wherein the secondary-side circuit further includes an additional resonant capacitor connected across the secondary winding.

13. A converter according to claim 1, wherein the secondary-side circuit further includes an output capacitor connected in parallel across the first and second output terminals.

14. A converter according to claim 13, wherein the output capacitor and the secondary inductor winding are connected together to define an output filter.

15. A converter according to claim 1, wherein the switching circuit includes at least two MOSFETs.

16. A converter according to claim 1, wherein the rectifier circuit includes at least two rectifiers.

17. A converter according to claim 16, wherein the at least two rectifiers are MOSFETs.

18. A converter according to claim 16, wherein the at least two rectifiers are diodes.

19. A converter according to claim 1, wherein the switching circuit has either a full-bridge or a push-pull topology.

20. A converter according to claim 1, wherein the rectifier circuit has either a full bridge or a center-tap scheme.

21. A converter according to claim 6, wherein the primary inductor winding, the secondary inductor winding, and the auxiliary inductor winding are coupled together by a magnetic core.
